(19) United States
(12) Patent Application Publication
(10) Pub. No.: US 2011/0241558 A1
(43) Pub. Date: Oct. 6, 2011

(54) Light-Emitting Device and Driving Method Thereof

(75) Inventors: Shunpei Yamazaki, Tokyo (JP); Kenichi Wakimoto, Atsugi (JP)

(73) Assignee: Semiconductor Energy Laboratory Co., Ltd.

(21) Appl. No.: 13/074,234

(22) Filed: Mar. 29, 2011

(30) Foreign Application Priority Data
Mar. 31, 2010 (JP) 2010-080756

(51) Int. Cl. H05B 41/16; H05B 37/02

(52) U.S. Cl. 315/250; 315/294

(57) ABSTRACT

It is an object to provide a light-emitting device whose light is not entirely turned off owing to disconnection (an insulation defect) in part of light-emitting elements and the whole of which can be driven by one constant current supply without causing variation in brightness. Further, it is an object to provide a light-emitting device in which brightness can be adjusted. In addition, it is an object to provide a light-emitting device in which change in properties of light-emitting elements over time due to the use thereof is less likely to appear as variation in brightness. In order to achieve the above object, a light-emitting device in which a plurality of light-emitting panels are connected to a constant current supply controlled by a light-emission control unit may be used, and each of the light-emitting panels may be sequentially driven, independently. The plurality of light-emitting panels provided in the light-emitting device may be used evenly so that difference in total operating time is not caused among them.

### BACKGROUND OF THE INVENTION

1. Field of the Invention

The present invention relates to a light-emitting device provided with a plurality of current control type light-emitting elements, and a driving method thereof.

2. Description of the Related Art

In recent years, research and development have been extensively conducted on light-emitting elements using electroluminescence. Such a light-emitting element has a structure in which a layer containing a light-emitting substance is interposed between a pair of electrodes. By application of voltage between the pair of electrodes, light emission can be obtained from the light-emitting substance.

Such a self-luminous light-emitting element has various features. For example, it has great features and advantages that such a self-luminous light-emitting element can be manufactured to be thin and lightweight and has very high response speed with respect to an input signal.

An electroluminescent material can be formed in a film form with a thickness of 1 μm or less by a formation method such as an evaporation method or a coating method, and thus surface light emission from a large area can be readily obtained. For example, a lighting device using electroluminescence, in which uniform luminance can be maintained even when its area is increased is disclosed (e.g., Patent Document 1). This is a feature which is difficult to be obtained in point light sources typified by an incandescent lamp and an LED or line light sources typified by a fluorescent bulb.

As a next-generation lighting device, a lighting device using an electroluminescent (EL) material has attracted attention because it is estimated to have higher emission efficiency than filament bulbs or fluorescent bulbs.

### REFERENCE

### Patent Document

[Patent Document 1] Japanese Published Patent Application No. 2005-332773

### SUMMARY OF THE INVENTION

However, current which flows through a light-emitting element including a layer containing a light-emitting organic compound between a first electrode and a second electrode tends to change extremely sensitively in response to a slight change in voltage applied between the first electrode and the second electrode. Specifically, in some cases, current changes roughly in proportion to the sixth power of the amount of change in voltage. Thus, there is a problem in that overcurrent flows through the light-emitting element owing to a slight change in driving voltage and breaks the light-emitting element.

Even in the case where a constant driving voltage is applied, overcurrent flows through the light-emitting element owing to variation in voltage-current properties which is caused in manufacture of the light-emitting element and breaks the light-emitting element itself, in some cases.

Meanwhile, emission luminance of the light-emitting element tends to increase substantially in proportion to the amount of current. Therefore, a driving method in which a constant current supply is used is more suitable for the light-emitting element than a driving method in which a constant voltage supply is used.

In the case where a light-emitting device is used as lighting, a lighting device provided with a function capable of changing brightness in accordance with its usage environment or applications, a so-called light adjusting function, is desirable.

In this, specification, one light-emitting element or a structure in which a plurality of light-emitting elements are connected in series is referred to as one light-emitting panel, and the brightness of one light-emitting panel connected to a constant current supply can be adjusted by control of current output from the constant current supply. However, in a structure including only serial connection, like the light-emitting panel, there is a problem in that light of the entire light-emitting device is turned off when disconnection occurs (when an insulation defect is caused) in part of the light-emitting elements. Since driving voltage is increased when the number of light-emitting elements connected in series is increased, there is also a problem in that a component which is excellent in withstand voltage characteristics needs to be used and thus an inexpensive component is difficult to use.

Meanwhile, in the case of a light-emitting device in which a plurality of light-emitting panels are connected in parallel to each other to one constant current supply, the brightness of the entire light-emitting device can be adjusted by control of current output from the constant current supply. Even when disconnection occurs (when an insulation defect is caused) in part of the light-emitting elements, light of the light-emitting device is not entirely turned off. However, in such a structure, since the amount of current flowing through each of the light-emitting panels can not be the same, there is a problem in that a light-emitting panel where current easily flows emits brighter light, and a light-emitting panel where current does not easily flow emits darker light; that is, the brightness of emitted light is different among the plurality of light-emitting panels.

As the operating time of the light-emitting elements increases, emission efficiency thereof decreases, and a light-emitting element of which the total operating time is longer emits darker light. Thus, there is a problem in that when unequal use of the plurality of light-emitting elements provided in the light-emitting device causes large difference in total operating time among the light-emitting elements, it is difficult to obtain uniform light emission even when the plurality of light-emitting elements are each driven by a constant current.

The present invention is made in view of the foregoing technical background. In a light-emitting device of one embodiment of the present invention, light is not entirely turned off owing to disconnection (an insulation defect) in part of light-emitting elements and the whole of the light-emitting device can be driven by one constant current supply without causing variation in brightness.

Further, in one embodiment of the present invention, brightness of a light-emitting device can be adjusted.

In addition, in a light-emitting device of one embodiment of the present invention, change in properties of light-emitting elements over time due to the use thereof is less likely to appear as variation in brightness.

In one embodiment of the present invention, a light-emitting device in which a plurality of light-emitting panels are connected to a constant current supply controlled by a light-emission control unit may be used, and each of the light-emitting panels may be sequentially driven, independently.

The plurality of light-emitting panels provided in the light-emitting device may be used evenly so that difference in total operating time is not caused among them.

One embodiment of the present invention is a light-emitting device including a plurality of light-emitting panels, a constant current supply supplying electric power to each of the light-emitting panels, a luminance control unit setting brightness of the light-emitting panels, and a light-emission control unit making an output of the constant current supply be sequentially supplied in accordance with a signal from the luminance control unit so that the light-emitting panels blink with the same frequency. The light-emitting panels each include a light-emitting element including a layer containing a light-emitting organic compound between a first electrode and a second electrode.

In the above light-emitting device, a problem in that light of the entire light-emitting device is turned off owing to disconnection (an insulation defect) in part of the light-emitting panels can, be prevented because a plurality of independent light-emitting panels are used. The luminance control unit and the light-emission control unit are used to control current output from the constant current supply to the light-emitting panels, whereby brightness can be adjusted. Since electric power is sequentially supplied to drive the plurality of light-emitting panels each including a light-emitting element including a layer containing a light-emitting organic compound between a first electrode and a second electrode, uniform surface light emission can be obtained.

One embodiment of the present invention is the light-emitting device, in which the light-emission control unit controls current output from the constant current supply.

Since light-emitting panels each including a current control type light-emitting element including a layer containing a light-emitting organic compound between a first electrode and a second electrode are used in the above light-emitting device, brightness of the light-emitting panels can be controlled by current. The plurality of light-emitting panels emit light with the same brightness with the use of the constant current supply.

One embodiment of the present invention is the light-emitting device, in which the light-emission control unit controls a pulse width of current output from the constant current supply.

In the above light-emitting device, light-emitting panels each including a light-emitting element which responds to an input signal at high speed and includes a layer containing a light-emitting organic compound between a first electrode and a second electrode are used; thus, brightness of the light-emitting panels can be controlled by a pulse width of pulsed current.

One embodiment of the present invention is the light-emitting device, in which the constant current supply supplies a constant current to each of the light-emitting panels with a frequency of greater than or equal to 100 Hz and less than or equal to 500 kHz in accordance with a control signal output from the light-emission control unit.

In the above light-emitting device, since the plurality of light-emitting panels are sequentially switched and lighted in sufficiently short periods, such lighting is recognized as continuous lighting by human eyes.

Furthermore, since independent light-emitting panels are used with roughly the same frequency, significant difference in total operating time is not caused among the light-emitting panels. Accordingly, the amount of change in properties of the light-emitting panels due to the use thereof is substantially the same, so that variation in light emission of the light-emitting device can be reduced.

One embodiment of the present invention is a light-emitting device including a plurality of light-emitting panels, a constant current supply supplying electric power to each of the light-emitting panels, a luminance control unit setting brightness of the light-emitting panels, and a light-emission control unit making an output of the constant current supply be sequentially supplied in accordance with a signal from the luminance control unit so that the light-emitting panels blink with the same frequency. The light-emitting panels each include a light-emitting element which includes a plurality of light-emitting units each containing an organic compound between a first electrode and a second electrode, and which also includes a charge generation layer between the plurality of light-emitting units.

The light-emitting element which includes a plurality of light-emitting units each containing an organic compound between a first electrode and a second electrode, and includes a charge generation layer between the plurality of light-emitting units, can emit light in a high luminance region with current density kept low and has a long lifetime; thus, a highly reliable light-emitting device can be provided.

One embodiment of the present invention is a driving method of a light-emitting device including the steps of preparing in light-emitting modules (m is more than or equal to 2 and less than or equal to 10) each of which is provided with n light-emitting panels (n is more than or equal to 2 and less than or equal to 10000) each provided with a light-emitting element including a layer containing a light-emitting organic compound between a first electrode and a second electrode, n first terminals electrically connected to the first electrode of each light-emitting panel, and n second terminals electrically connected to the second electrode of each light-emitting panel; connecting one of the second terminals for the light-emitting panels provided in one of the light-emitting modules to one of the first terminals for the light-emitting panels provided in another one of the light-emitting modules to form n light-emitting bodies in each of which m light-emitting panels are connected in series; connecting a terminal connected to each first electrode of the n light-emitting bodies to one electrode of a constant current supply, connecting a terminal connected to each second electrode of the n light-emitting bodies to the other electrode of the constant current supply; and supplying electric power to the n light-emitting bodies from the constant current supply controlled by a light-emission control unit in accordance with a signal from a luminance control unit to blink the n light-emitting bodies with the same frequency.

By using the above method for connecting the light-emitting modules, the light emission area of the light-emitting device can be increased without additionally providing any of a luminance control unit, a light-emission control unit, and a constant current supply, which is convenient.

Thus, a light-emitting device can have a long lifetime with its brightness as a whole kept uniform.

Note that in this specification, an “EL layer” refers to a layer provided between a pair of electrodes in a light-emitting element. Thus, a light-emitting layer containing an organic compound that is a light-emitting substance which is interposed between electrodes is an embodiment of the EL layer.

In this specification, in the case where a substance A is dispersed in a matrix formed using a substance B, the substance B forming the matrix is referred to as a host material, and the substance A dispersed in the matrix is referred to as a guest material. Note that the substance A and the substance B may each be a single substance or a mixture of two or more kinds of substances.

According to one embodiment of the present invention, a light-emitting device in which driving and light adjustment can be performed using one constant current supply without the entire lighting being turned off by disconnection (an insulation defect) in part of light-emitting elements can be provided. Further, a light-emitting device in which light can be adjusted without unequal use of part of a plurality of light-emitting elements can be provided.

### BRIEF DESCRIPTION OF THE DRAWINGS

FIG. 1 illustrates a structure of a light-emitting device according to an embodiment.

FIG. 2 is a timing chart illustrating a driving method of a light-emitting device according to an embodiment.

FIG. 3 illustrates a structure of a light-emitting device according to an embodiment.

FIG. 4 is a timing chart illustrating a driving method of a light-emitting device according to an embodiment.

FIG. 5 illustrates a structure of a light-emitting device according to an embodiment.

FIG. 6 illustrates a structure of a light-emitting element according to an embodiment.

FIG. 7 illustrates a structure of a light-emitting element according to an embodiment.

FIG. 8 illustrates a structure of a light-emitting device according to an embodiment.

FIG. 9 illustrates a structure of a light-emitting device according to an embodiment.

FIG. 10 illustrates a structure of a light-emitting device according to an embodiment.

### DETAILED DESCRIPTION OF THE INVENTION

Embodiments will be described in detail with reference to the accompanying drawings. Note that the present invention is not limited to the following description, and it will be easily understood by those skilled in the art that various changes and modifications can be made without departing from the spirit and scope of the present invention. Therefore, the present invention should not be construed as being limited to the description in the following embodiments. Note that in the structures of the invention described below, the same portions or portions having similar functions are denoted by the same reference numerals in different drawings, and description of such portions is not repeated.

### Embodiment 1

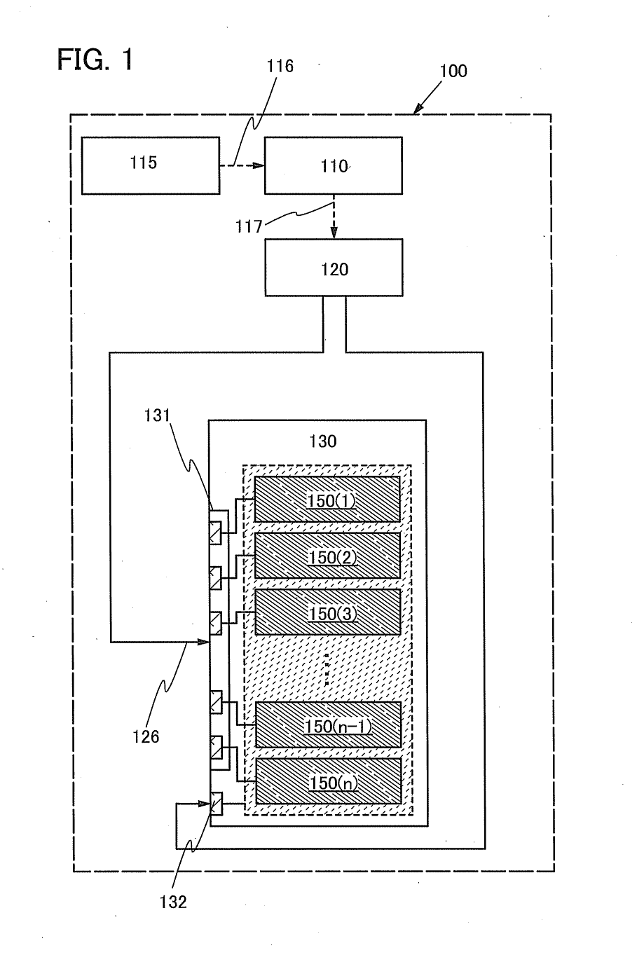

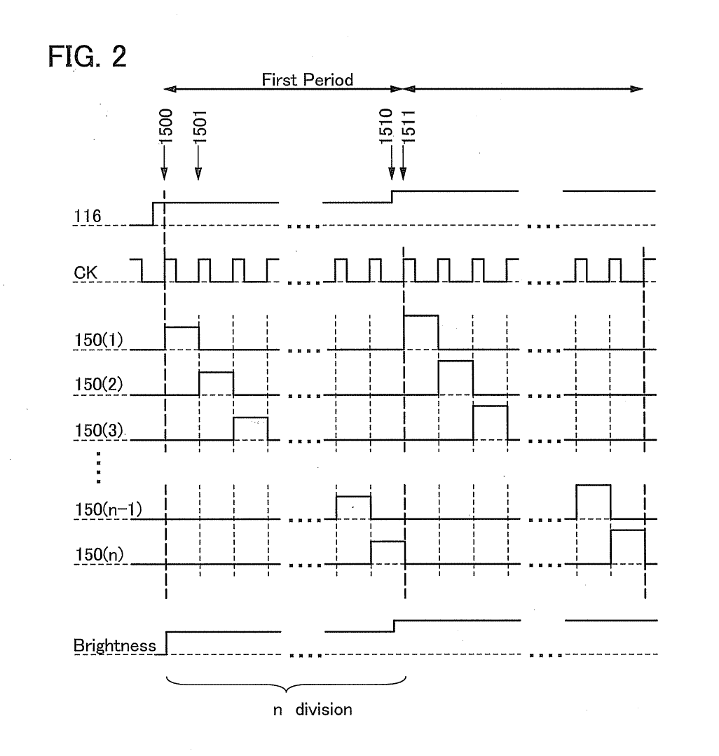

In this embodiment, a light-emitting device in which a plurality of light-emitting panels are connected to a constant current supply controlled by a light-emission control unit will be described with reference to FIG. 1 and FIG. 2.

FIG. 1 illustrates a structure of a light-emitting device 100 described in this embodiment. The light-emitting device 100 is provided with a light-emitting module 130, a constant current supply 120, a light-emission control unit 110, and a luminance control unit 115. The luminance control unit 115 is connected to the light-emission control unit 110 and outputs a setting signal 116 for adjusting brightness. The light-emission control unit 110 is connected to the constant current supply 120 and outputs a control signal 117. The constant current supply 120 is connected to the light-emitting module 130 and supplies a constant current 126.

The light-emitting module 130 is provided with n light-emitting panels 150(1) to 150(n), a terminal portion 131, and a terminal portion 132. Note that n is an integer of more than or equal to 2 and less than or equal to 10000, preferably more than or equal to 4 and less than or equal to 100. When n is more than or equal to 2, a problem in that light of the entire light-emitting module is turned off owing to a defect caused in one light-emitting panel can be prevented. Further, when n is more than or equal to 4, the possibility of light of the entire light-emitting module being turned off is extremely lowered and the light-emitting panel where a defect is caused is inconspicuous, which is preferable. When n is less than or equal to 10000, a light-emitting element can respond to the input current at sufficiently high speed and can be lighted with substantially the same brightness as in the case where the light-emitting element is always lighted. Further, when n is less than or equal to 100, the area of wirings connecting the light-emitting panels to terminals can be made small and the area of the light-emitting panels can be made large, which is preferable. Although the light-emitting panels 150(1) to 150(n) exhibiting the same emission color are provided in the light-emitting module 130 described in this embodiment, light-emitting panels exhibiting different emission colors may be provided.

The peak of driving voltage input to the light-emitting module 130 is preferably greater than or equal to 2.5 V and less than or equal to 300 V, far preferably greater than or equal to 3.5 V and less than or equal to 30 V. When the driving voltage for the light-emitting module 130 is greater than or equal to 2.5 V, a boosting circuit need not be provided in the module, whereby the light-emitting module can be provided at low cost. When the driving voltage is greater than or equal to 3.5 V, light including blue light can be emitted. When the driving voltage for the light-emitting module 130 is less than or equal to 300 V, power consumption can be reduced, a component with high withstand voltage characteristics need not be used for a circuit connected to the light-emitting module, and the light-emitting device can be provided at low cost. When the driving voltage is less than or equal to 30 V, a versatile component can be used, which is convenient.

The light-emitting panels 150(1) to 150(n) are each provided with one or more surface-emitting light-emitting elements. When the surface-emitting light-emitting elements are used for the light-emitting panels, a light-emitting device whose brightness is uniform can be provided. As the surface-emitting light-emitting element, a light-emitting element including a layer containing a light-emitting organic compound between a first electrode and a second electrode is preferable.

Note that although the light-emitting panels 150(1) to 150(n) described in this embodiment are each provided with one same light-emitting element, different light-emitting elements may be provided or a plurality of elements connected in series may be provided. Alternatively, for example, a mixture of light-emitting elements of different emission colors may be provided. When light-emitting elements of different emission colors are combined, color rendering properties of the light-emitting device can be improved.

The terminal portion 131 and the terminal portion 132 are each provided with one or more terminals, and first electrodes of the light-emitting panels 150(1) to 150(n) are independently connected to terminals provided in the terminal portion 131 and a second electrode thereof is connected to a terminal provided in the terminal portion 132.

In the light-emitting module 130 described in this embodiment, the terminal portion 131 includes n independent terminals and the terminal portion 132 includes one terminal. The light-emitting panels 150(1) to 150(n) each include an independent first electrode, and include a common second electrode. The n terminals provided in the terminal portion 131 are connected to the respective independent first electrodes, and the terminal provided in the terminal portion 132 is connected to the common second electrode.

The constant current supply 120 outputs the constant current 126 in accordance with the control signal 117 from the light-emission control unit 110. One of the light-emitting panels 150(1) to 150(n) is connected to the constant current supply 120 as a load; however, the constant current supply 120 outputs the same amount of current regardless of the amount of the load. Note that the constant current supply may be formed with the use of a constant current circuit including only a power supply and a transistor.

The constant current supply 120 is preferably provided with a protection circuit so that the maximum current flowing through the light-emitting device is restricted, in which case a problem of overcurrent due to breakdown of the light-emitting module breaking the light-emitting device can be prevented.

The light-emission control unit 110 outputs the control signal 117 corresponding to the setting signal 116 for adjusting brightness output from the luminance control unit 115, to the constant current supply 120. The light-emission control unit 110 sequentially selects one light-emitting panel from the n light-emitting panels, so that the light-emitting panels are used with substantially the same frequency. Note that a circuit which outputs a clock signal CK is provided in the light-emission control unit 110.

The luminance control unit 115 may be a unit operated directly by a user, or may be an external device such as a photo sensor for detecting brightness or a timer.

Next, a method by which the light-emission control unit 110 adjusts brightness of the light-emitting device will be described. An example of a driving method is described using a timing chart in FIG. 2. In FIG. 2, CK is a clock signal, and timings at which the constant current 126 is supplied to the light-emitting panels 150(1) to 150(n) from the constant current supply 120 are shown.

### <First Step>

The setting signal 116 for adjusting brightness is input to the light-emission control unit 110 from the luminance control unit 115, and then the light-emission control unit 110 outputs the control signal 117 for selecting the light-emitting panel 150(1) to the constant current supply 120. The constant current supply 120 prepares for output of the constant current 126 whose amount corresponds to the control signal 117 corresponding to the setting signal 116. Then, the constant current supply 120 supplies the constant current 126 to the light-emitting panel 150(1) during a period between time 1500 and time 1501.

In the case where the light-emitting module 130 is lighted with increased brightness, a larger amount of current may be supplied from the constant current supply 120, and in the case where the light-emitting module 130 is lighted with decreased brightness, a smaller amount of current may be supplied. The amount of current flowing through the light-emitting module is roughly proportional to the brightness.

A known method may be used for changing the amount of current output from the constant current supply 120. For example, the setting signal 116 for adjusting brightness may be input to a comparator so that output of the constant current supply 120 is adjusted.

Note that output of the clock signal CK may be started in advance together with power supply to the light-emitting device, or may be started together with the output of the setting signal 116.

### <Second Step>

Then, the light-emission control unit 110 outputs the control signal 117 for selecting the light-emitting panel 150(2) to the constant current supply 120. The constant current supply 120 starts to supply the constant current 126 to the light-emitting panel 150(2) at time 1501. In such a manner, the light-emission control unit 110 makes the constant current supply 120 sequentially supply the constant current 126 to the n light-emitting panels 150(1) to 150(n) in synchronization with the clock signal CK.

The constant current supply 120 switches the light-emitting panels so that each light-emitting panel emits light with a frequency of greater than or equal to 100 Hz and less than or equal to 500 kHz, in accordance with the control signal 117. For example, in the case where the light-emitting module 130 provided with the n light-emitting panels emits light with a frequency of 100 Hz, the light-emitting panels are switched so that the light emission time of each light-emitting panel is (10/n) milliseconds. In this embodiment, the light-emitting panels are switched in accordance with the frequency of the clock signal CK.

When each light-emitting panel is lighted with a frequency of greater than or equal to 100 Hz, preferably greater than or equal to 120 Hz, flicker of the light-emitting device can be prevented. When the frequency is less than or equal to 500 kHz, it is relatively easy to prevent electromagnetic interference (EMI) or the like. Note that in this embodiment, the constant current supply 120 supplies the constant current 126 to the n light-emitting panels for the same length of period each, in accordance with the control signal 117 output from the light-emission control unit 110.

The constant current supply 120 supplies the constant current 126 to only one light-emitting panel at a time in accordance with the control signal 117. Therefore, even when the ease of current flow varies among the plurality of light-emitting panels provided in the light-emitting module 130, the same amount of current flows through each light-emitting panel.

Note that the light-emitting elements, each including a layer containing a light-emitting organic compound between the first electrode and the second electrode, of the light-emitting panels emit light with the same brightness when the same amount of current is supplied. Accordingly, when the method described in this embodiment is used, the plurality of light-emitting panels of the light-emitting device 100 can emit light with substantially the same brightness.

### <Third Step>

Next, description is made of a case where brightness is changed. At time 1510 when the value of the setting signal 116 for adjusting brightness from the luminance control unit 115 is changed, the light-emission control unit 110 outputs the control signal 117 corresponding to the setting signal 116 to the constant current supply 120. The constant current supply 120 changes the amount of current to output in accordance with the control signal 117. Thus, the amount of current which is supplied to the light-emitting panels after time 1511 is changed, whereby the brightness of the light-emitting device can be changed.

In the above light-emitting device, a problem in that light of the entire light-emitting device is turned off owing to disconnection (an insulation defect) in part of the light-emitting panels can be prevented because a plurality of independent light-emitting panels are used. The luminance control unit and the light-emission control unit are used to control current output from the constant current supply to the light-emitting panels, whereby brightness can be adjusted.

Since light-emitting panels each including a current control type light-emitting element including a layer containing a light-emitting organic compound between a first electrode and a second electrode are used in the above light-emitting device, brightness of the light-emitting panels can be controlled by current. The plurality of light-emitting panels emit light with the same brightness with the use of the constant current supply.

In the above light-emitting device, since the plurality of light-emitting panels are sequentially switched and lighted in sufficiently short periods, such lighting is recognized as continuous lighting by human eyes.

Furthermore, since independent light-emitting panels are used with roughly the same frequency, significant difference in total operating time is not caused among the light-emitting panels. Accordingly, the amount of change in properties of the light-emitting panels due to the use thereof is substantially the same, so that variation in light emission of the light-emitting device can be reduced.

Thus, a light-emitting device can have a long lifetime with its brightness as a whole kept uniform.

This embodiment can be freely combined with any of the other embodiments in this specification.

### Embodiment 2

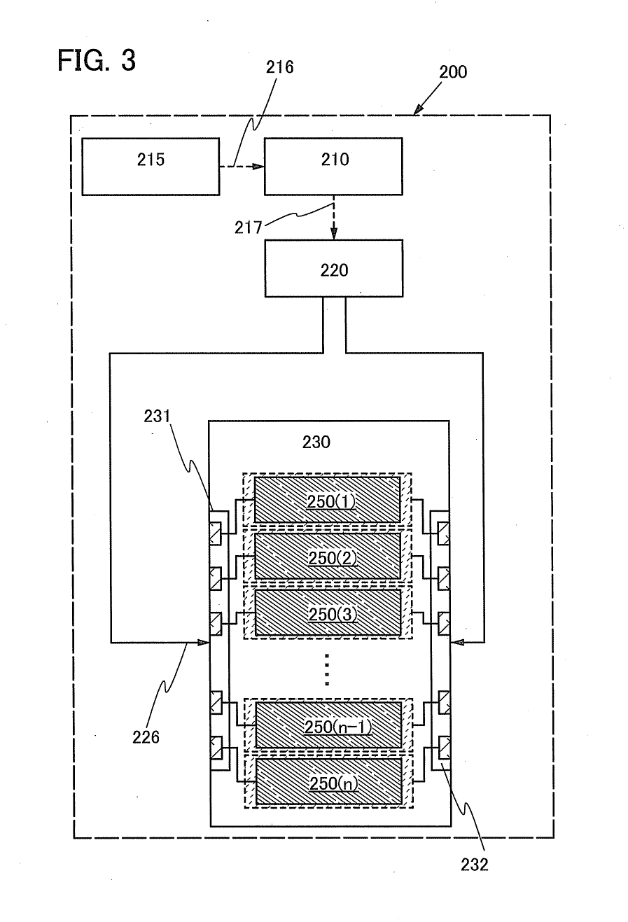

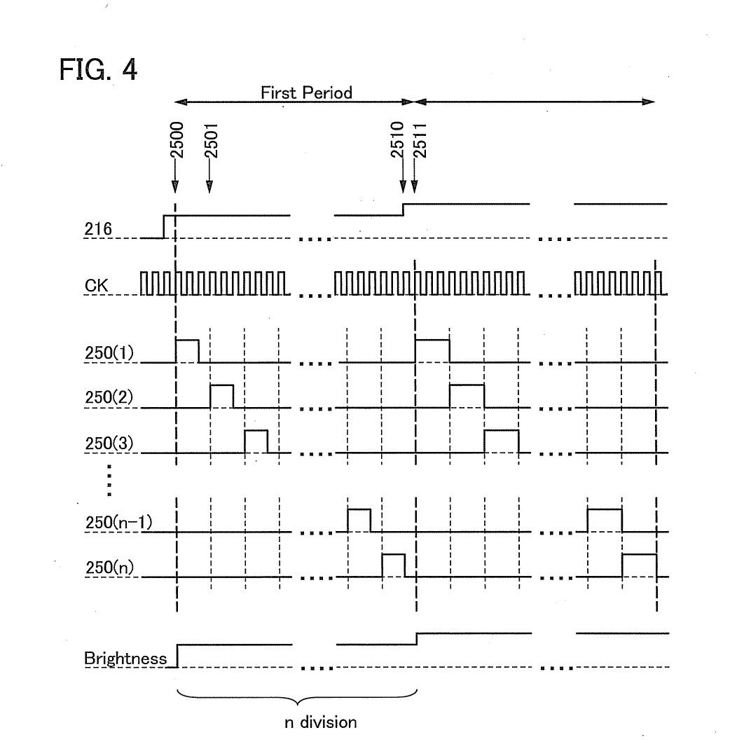

In this embodiment, one mode of a light-emitting device in which brightness is controlled by a method different from that in Embodiment 1 will be described with reference to FIG. 3 and FIG. 4. Specifically, a light-emitting device in which brightness is controlled by changing a pulse width of current supplied from a constant current supply will be described.

FIG. 3 illustrates a structure of a light-emitting device 200 described in this embodiment. The light-emitting device 200 is provided with a light-emitting module 230, a constant current supply 220, a light-emission control unit 210, and a luminance control unit 215. The luminance control unit 215 is connected to the light-emission control unit 210 and outputs a setting signal 216 for adjusting brightness. The light-emission control unit 210 is connected to the constant current supply 220 and outputs a control signal 217. The constant current supply 220 is connected to the light-emitting module 230 and supplies a pulsed constant current 226.

The light-emitting module 230 is provided with n light-emitting panels 250(1) to 250(n), a terminal portion 231, and a terminal portion 232. Note that n is an integer of more than or equal to 2 and less than or equal to 10000, preferably more than or equal to 4 and less than or equal to 100. Although the light-emitting panels 250(1) to 250(n) exhibiting the same emission color are provided in the light-emitting module 230 described in this embodiment, light-emitting panels exhibiting different emission colors may be provided.

The light-emitting panels 250(1) to 250(n) are each provided with one or more surface-emitting light-emitting elements. When the surface-emitting light-emitting elements are used for the light-emitting panels, a light-emitting device whose brightness is uniform can be provided. As the surface-emitting light-emitting element, a light-emitting element including a layer containing a light-emitting organic compound between a first electrode and a second electrode is preferable.

Note that although the light-emitting panels 250(1) to 250(n) described in this embodiment are each provided with one same light-emitting element, different light-emitting elements may be provided or a plurality of elements connected in series may be provided. Alternatively, for example, a mixture of light-emitting elements of different emission colors may be provided. When light-emitting elements of different emission colors are combined, color rendering properties of the light-emitting device can be improved.

The terminal portion 231 and the terminal portion 232 are each provided with one or more terminals, and the light-emitting panels 250(1) to 250(n) are independently connected to the terminals.

In the light-emitting module 230 described in this embodiment, the terminal portion 231 includes n independent terminals and the terminal portion 232 includes another n independent terminals. The light-emitting panels 250(1) to 250(n) each include an independent first electrode and an independent second electrode. The n terminals provided in the terminal portion 231 are connected to the respective independent first electrodes, and the n terminals provided in the terminal portion 232 are connected to the respective independent second electrodes.

The constant current supply 220 outputs the pulsed constant current 226 in accordance with the control signal 217 from the light-emission control unit 210. One of the light-emitting panels 250(1) to 250(n) is connected to the constant current supply 220 as a load; however, the constant current supply 220 outputs the same amount of pulsed current regardless of the amount of the load.

The constant current supply 220 is preferably provided with a protection circuit so that the maximum current flowing through the light-emitting device is restricted, in which case a problem of overcurrent due to breakdown of the light-emitting module breaking the light-emitting device can be prevented.

The light-emission control unit 210 outputs the control signal 217 corresponding to the setting signal 216 for adjusting brightness output from the luminance control unit 215, to the constant current supply 220. The light-emission control unit 210 sequentially selects one light-emitting panel from the n light-emitting panels, so that the light-emitting panels are used with substantially the same frequency. Note that a circuit which outputs a clock signal CK and a counter circuit are provided in the light-emission control unit 210. The light-emission control unit 210 outputs the control signal 217 in accordance with a signal from the counter circuit that counts clock signals. The constant current supply 220 modulates the pulse width of the constant current 226 in accordance with the control signal 217. Further, the constant current supply 220 outputs the pulsed constant current 226 to one of the light-emitting panels 250(1) to 250(n) in accordance with the control signal 217.

The luminance control unit 215 may be a unit operated directly by a user, or may be an external device such as a photo sensor for detecting brightness or a timer.

Next, a method by which the light-emission control unit 210 adjusts brightness of the light-emitting device will be described. An example of a driving method is described using a timing chart in FIG. 4. In FIG. 4, CK is a clock signal. Timings and pulse widths of the pulsed constant current output to the light-emitting panels 250(1) to 250(n) from the constant current supply are shown.

### <First Step>

The setting signal 216 for adjusting brightness is input to the light-emission control unit 210 from the luminance control unit 215, and then the light-emission control unit 210 outputs the control signal 217 for selecting the light-emitting panel 250(1) to the constant current supply 220. The constant current supply 220 prepares for output of the pulsed constant current 226 whose pulse width corresponds to the control signal 217 corresponding to the setting signal 216. Then, the constant current supply 220 starts to supply the pulsed constant current 226 to the light-emitting panel 250(1) at time 2500.

Note that in the case where the light-emitting module 230 is lighted with increased brightness, the constant current supply 220 may supply a longer-pulsed constant current, and in the case where the light-emitting module 230 is lighted with decreased brightness, a shorter-pulsed constant current may be supplied.

As a method for changing the pulse width of the pulsed constant current output from the constant current supply 220, a known method may be used. For example, a clock signal CK and a pulse width modulation (PWM) circuit may be used to control the pulse width. Note that the output of the clock signal CK may be started in advance together with power supply to the light-emitting device 200, or may be started together with the output of the setting signal 216.

### <Second Step>

Then, the light-emission control unit 210 outputs the control signal 217 for selecting the light-emitting panel 250(2) to the constant current supply 220. The constant current supply 220 starts to supply the pulsed constant current 226 to the light-emitting panel 250(2) at time 2501. In such a manner, the light-emission control unit 210 makes the constant current supply 220 sequentially supply the pulsed constant current 226 to the n light-emitting panels 250(1) to 250(n) in synchronization with the clock signal CK. The clock signal CK is input plural times between time 2500 and time 2501.

Thus, the light-emission control unit 210 outputs the control signal 217 that synchronizes with the clock signal CK, and the constant current supply 220 supplies the pulsed constant current 226 to the n light-emitting panels 250(1) to 250(n) in accordance with the control signal 217.

The light-emitting panels are switched so that each light-emitting panel emits light with a frequency of greater than or equal to 100 Hz and less than or equal to 500 kHz. For example, in the case where the light-emitting module 230 provided with the n light-emitting panels emits light with a frequency of 100 Hz, the light-emitting panels are switched so that the light emission time of each light-emitting panel is (10/n) milliseconds. In this embodiment, the light-emitting panels are switched in accordance with the frequency of the clock signal CK.

When each light-emitting panel is lighted with a frequency of greater than or equal to 100 Hz, preferably greater than or equal to 120 Hz, flicker of the light-emitting device can be prevented. When the frequency is less than or equal to 500 kHz, interference such as electromagnetic interference (EMI) can be prevented. Note that in this embodiment, the constant current supply 220 supplies the pulsed constant current 226 to the n light-emitting panels, in accordance with the control signal 217 output from the light-emission control unit 210.

The constant current supply 220 supplies the pulsed constant current 226 to only one light-emitting panel at a time in accordance with the control signal 217. Therefore, even when the ease of current flow varies among the plurality of light-emitting panels provided in the light-emitting module 230, the same amount of current flows through each light-emitting panel.

Note that the light-emitting elements, each including a layer containing a light-emitting organic compound between the first electrode and the second electrode, of the light-emitting panels emit light with the same brightness when the same amount of current with the same pulse width is supplied. Accordingly, when the method described in this embodiment is used, the plurality of light-emitting panels of the light-emitting device 200 can emit light with substantially the same brightness.

### <Third Step>

Next, description is made of a case where brightness is changed. At time 2510 when the value of the setting signal 216 for adjusting brightness is changed using the luminance control unit 215, the light-emission control unit 210 changes the pulse width of the pulsed constant current output from the constant current supply 220 to a pulse width corresponding to the control signal 217 corresponding to the setting signal 216. Thus, the pulse width of the pulsed constant current which is supplied to the light-emitting panels after time 2511 is changed, whereby brightness of the light-emitting device can be changed. In the case where the light-emitting module 230 is lighted with increased brightness, the pulse width of the pulsed constant current may be made longer, and in the case where the light-emitting module 230 is lighted with decreased brightness, the pulse width of the pulsed constant current may be made shorter.

In the above light-emitting device, a problem in that light of the entire light-emitting device is turned off owing to disconnection (an insulation defect) in part of the light-emitting panels can be prevented because a plurality of independent light-emitting panels are used. The luminance control unit and the light-emission control unit are used to control a pulse width of current output from the constant current supply to the light-emitting panels, whereby brightness can be adjusted.

Since light-emitting panels each including a current control type light-emitting element including a layer containing a light-emitting organic compound between a first electrode and a second electrode are used in the above light-emitting device, brightness of the light-emitting panels can be controlled by current. The plurality of light-emitting panels emit light with the same brightness with the use of the constant current supply.

In the above light-emitting device, since the plurality of light-emitting panels are sequentially switched and lighted in sufficiently short periods, such lighting is recognized as continuous lighting by human eyes.

Furthermore, since independent light-emitting panels are used with roughly the same frequency, significant difference in total operating time is not caused among the light-emitting panels. Accordingly, the amount of change in properties of the light-emitting panels due to the use thereof is substantially the same, so that variation in light emission of the light-emitting device can be reduced.

Thus, a light-emitting device can have a long lifetime with its brightness as a whole kept uniform.

In this embodiment, the case where the brightness of the light-emitting device is adjusted by using only the pulse width of the pulsed constant current is described; however, brightness may be adjusted by changing the duty ratio without changing the pulse width, and the current value of the pulsed constant current may also be changed. For example, the current control of the constant current supply described in Embodiment 1 and the control of the pulse width described in this embodiment may be used in combination. For example, in the case where it is desired that the brightness of the room is suppressed to make a calm atmosphere, output of the constant current supply is suppressed and the pulse width is adjusted to adjust light, and in the case where the brightness of the room is increased, output of the constant current supply is increased and the pulse width is adjusted to adjust light. Such combination can drastically extend the adjustable range of light.

This embodiment can be freely combined with any of the other embodiments in this specification.

### Embodiment 3

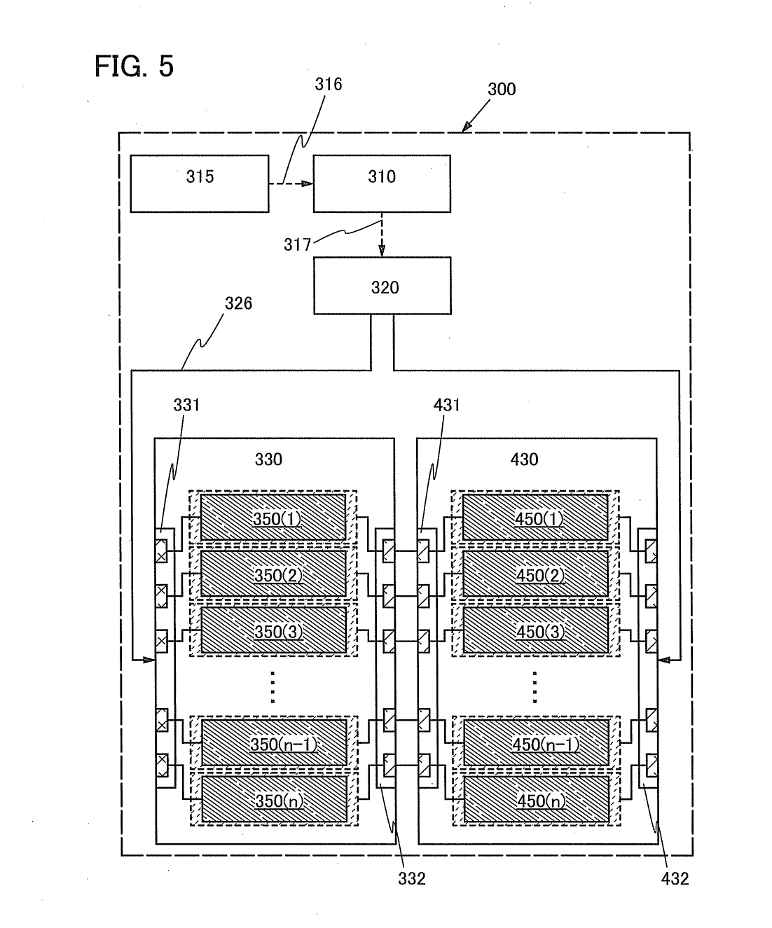

In this embodiment, one mode of a method for connecting light-emitting modules which can be applied to the light-emitting devices described in Embodiments 1 and 2 will be described with reference to FIG. 5.

Specifically, a method for connecting light-emitting modules, in which a light-emitting module 330 and a light-emitting module 430 each having the same structure as the light-emitting module 230 described in Embodiment 2 are connected to each other and light-emitting panels in the light-emitting module 330 and light-emitting panels in the light-emitting module 430 are connected in series so that new light-emitting panels (light-emitting bodies) are formed is described.

FIG. 5, illustrates a structure of a light-emitting device 300 described in this embodiment. The light-emitting device 300 is provided with the light-emitting module 330, the light-emitting module 430, a constant current supply 320, a light-emission control unit 310, and a luminance control unit 315. The luminance control unit 315 is connected to the light-emission control unit 310 and outputs a setting signal 316 for adjusting brightness. The light-emission control unit 310 is connected to the constant current supply 320 and outputs a control signal 317. The light-emitting module 330 and the light-emitting module 430 are connected to each other and a constant current 326 is supplied thereto from the constant current supply 320.

The light-emitting module 330 and the light-emitting module 430 each have the same structure as the light-emitting module 230. Specifically, the light-emitting module 330 includes n light-emitting panels 350(1) to 350(n), a terminal portion 331, and a terminal portion 332, and the light-emitting module 430 includes n light-emitting panels 450(1) to 450(n), a terminal portion 431, and a terminal portion 432. Note that n is an integer of more than or equal to 2 and less than or equal to 10000, preferably more than or equal to 4 and less than or equal to 100. Although the light-emitting module 330 and the light-emitting module 430 described in this embodiment include the light-emitting panels 350(1) to 350(n) and the light-emitting panels 450(1) to 450(n) exhibiting the same emission color, respectively, light-emitting panels exhibiting different emission colors may be provided in combination.

The light-emitting panels 350(1) to 350(n) and the light-emitting panels 450(1) to 450(n) each include one or more surface-emitting light-emitting elements. When the surface-emitting light-emitting elements are used for the light-emitting panels, a light-emitting device whose brightness is uniform can be provided. As the surface-emitting light-emitting element, a light-emitting element including a layer containing a light-emitting organic compound between a first electrode and a second electrode is preferable.

Note that although the light-emitting panels 350(1) to 350(n) and the light-emitting panels 450(1) to 450(n) described in this embodiment are each provided with one same light-emitting element, different light-emitting elements may be provided or a plurality of elements connected in series may be provided. Alternatively, for example, a mixture of light-emitting elements of different emission colors may be provided. When light-emitting elements of different emission colors are combined, color rendering properties of the light-emitting device can be improved.

The terminal portion 331 and the terminal portion 332 are each provided with one or more terminals, and the light-emitting panels 350(1) to 350(n) are independently connected to the terminals.

In the light-emitting module 330 described in this embodiment, the terminal portion 331 includes n independent terminals and the terminal portion 332 includes another n independent terminals. The light-emitting panels 350(1) to 350(n) each include an independent first electrode and an independent second electrode. The n terminals provided in the terminal portion 331 are connected to the respective independent first electrodes, and the n terminals provided in the terminal portion 332 are connected to the respective independent second electrodes.

The terminal portion 431 and the terminal portion 432 are each provided with one or more terminals, and the light-emitting panels 450(1) to 450(n) are independently connected to the terminals.

In the light-emitting module 430 described in this embodiment, the terminal portion 431 includes n independent terminals and the terminal portion 432 includes another n independent terminals. The light-emitting panels 450(1) to 450(n) each include an independent first electrode and an independent second electrode. The n terminals provided in the terminal portion 431 are connected to the respective independent first electrodes, and the n terminals provided in the terminal portion 432 are connected to the respective independent second electrodes.

In this embodiment, one of the light-emitting panels provided in the light-emitting module 330 and one of the light-emitting panels provided in the light-emitting module 430 are connected to each other through one of the terminals provided in the terminal portion 332 and one of the terminals provided in the terminal portion 431. Specifically, the light-emitting panel 350(n) provided in the light-emitting module 330 and the light-emitting panel 450(n) provided in the light-emitting module 430 are connected in series through a terminal provided in the terminal portion 332 and a terminal provided in the terminal portion 431.

According to this embodiment, independent light-emitting panels of two light-emitting modules are connected in series so that the size of the light-emitting panel can be substantially increased. In this embodiment, two light-emitting modules are connected; however, the number of light-emitting modules to be connected is not limited to two. More than two light-emitting modules can be connected by selecting capacitance of the constant current supply 320 and withstand voltage of each component as appropriate. When the number of light-emitting modules to be connected is increased, the size of the light-emitting panel can be substantially increased. For example, more than or equal to 2 and less than or equal to 10 light-emitting modules can be connected. When more than 10 light-emitting panels are connected, driving voltage may increase, and accordingly, a component excellent in withstand voltage characteristics needs to be used.

By using the above method for connecting the light-emitting modules, the light emission area of the light-emitting device can be increased without additionally providing any of the luminance control unit 315, the light-emission control unit 310, and the constant current supply 320, which is convenient.

Thus, a light-emitting device can have a long lifetime with its brightness as a whole kept uniform.

This embodiment can be freely combined with any of the other embodiments in this specification.

### Embodiment 4

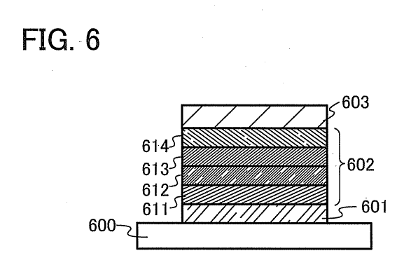

In this embodiment, one mode of a light-emitting element including a layer containing a light-emitting organic compound between a first electrode and a second electrode will be described with reference to FIG. 6.

The light-emitting element according to this embodiment includes a plurality of layers interposed between a pair of electrodes. The plurality of layers is a combination of a layer containing a substance having a high carrier-injection property and a layer containing a substance having a high carrier-transport property which are stacked so that a light-emitting region is formed apart from the electrodes, in other words, carriers are recombined in a portion apart from the electrodes.

In this embodiment, the light-emitting element illustrated in FIG. 6 includes a first electrode 601, a second electrode 603, and a layer 602 containing an organic compound which is formed between the first electrode 601 and the second electrode 603. Note that in this embodiment, description is given below assuming that the first electrode 601 serves as an anode and the second electrode 603 serves as a cathode. In other words, in the description below, it is assumed that light emission can be obtained when voltage is applied to the first electrode 601 and the second electrode 603 so that the potential of the first electrode 601 is higher than that of the second electrode 603.

A substrate 600 is used as a support of the light-emitting element. As the substrate 600, glass, plastic, or the like can be used, for example. Note that the substrate 600 may alternatively be formed using any other material as long as the material can support the light-emitting element during the manufacturing process.

The first electrode 601 is preferably formed using metal, an alloy, a conductive compound, a mixture thereof, or the like each having a high work function (specifically, 4.0 eV or higher). Specifically, for example, indium oxide-tin oxide (ITO: Indium Tin Oxide), indium oxide-tin oxide containing silicon or silicon oxide, indium oxide-zinc oxide (IZO: Indium Zinc Oxide), indium oxide containing tungsten oxide and zinc oxide (IWZO), and the like are given. Films of these conductive metal oxides are usually formed by sputtering; however, a sol-gel method or the like may also be used. For example, indium oxide-zinc oxide (IZO) can be fainted by a sputtering method using indium oxide into which zinc oxide of 1 wt % to 20 wt % is added, as a target. Moreover, indium oxide containing tungsten oxide and zinc oxide (IWZO) can be formed by a sputtering method using a target in which 0.5 wt % to 5 wt % of tungsten oxide and 0.1 wt % to 1 wt % of zinc oxide with respect to indium oxide are contained. In addition, gold (Au), platinum (Pt), nickel (Ni), tungsten (W), chromium (Cr), molybdenum (Mo), iron (Fe), cobalt (Co), copper (Cu), palladium (Pd), a nitride of a metal material (such as titanium nitride), or the like can be used.

When a layer containing a composite material which is described later is used as a layer in contact with the first electrode 601, the first electrode 601 can be formed using any of a variety of metals, alloys, electrically conductive compounds, a mixture thereof, or the like regardless of their work functions. As the composite material, for example, aluminum (Al), silver (Ag), an alloy containing aluminum (e.g., AlSi), or the like can be used. Alternatively, any of the following low-work function materials can be used: Group 1 and Group 2 elements of the periodic table, that is, alkali metals such as lithium (Li) and cesium (Cs) and alkaline-earth metals such as magnesium (Mg), calcium (Ca), and strontium (Sr), and alloys thereof (MgAg, AlLi); rare earth metals such as europium (Eu) and ytterbium (Yb), and alloys thereof; and the like. A film of an alkali metal, an alkaline earth metal, or an alloy containing these metals can be formed by a vacuum evaporation method. An alloy containing an alkali metal or an alkaline earth metal can also be formed by a sputtering method. Further, a silver paste or the like can be formed by an inkjet method or the like.

There is no particular limitation on a stacked structure of the layer 602 containing an organic compound. The layer 602 containing an organic compound may have a structure in which one or more of layers including a substance having a high electron-transport property, a substance having a high hole-transport property, a substance having a high electron-injection property, a substance having a high hole-injection property, a bipolar substance (a substance having a high electron-transport property and a high hole-transport property), and/or the like is combined with a light-emitting layer described in this embodiment, as appropriate. For example, the layer 602 can be formed in an appropriate combination of a hole-injection layer, a hole-transport layer, a light-emitting layer, an electron-transport layer, an electron-injection layer, and the like. In this embodiment, description is given on a structure in which the layer 602 containing an organic compound includes a hole-injection layer 611, a hole-transport layer 612, a light-emitting layer 613, and an electron-transport layer 614 stacked in that order over the first electrode 601. Specific materials to form each of the layers will be given below.

The hole-injection layer 611 is a layer containing a substance having a high hole-injection property. Molybdenum oxide, vanadium oxide, ruthenium oxide, tungsten oxide, manganese oxide, or the like can be used. Alternatively, the hole-injection layer 611 can be formed using a phthalocyanine-based compound such as phthalocyanine (abbreviation: H₂Pc) or copper phthalocyanine (abbreviation: CuPc); an aromatic amine compound such as 4,4′-bis[N-(4-diphenylaminophenyl)-N-phenylamino]biphenyl (abbreviation: DPAB) or N,N′-bis[4-[bis(3-methylphenyl)amino]phenyl]-N,N′-diphenyl-[1,1′-biphenyl]-4,4′-diamine (abbreviation: DNTPD); a high molecular compound such as poly(3,4-ethylenedioxythiophene)/poly(styrenesulfonic acid) (PEDOT/PSS); or the like. Further, the hole-injection layer 611 can be formed using a tris(p-enamine-substituted-aminophenyl)amine compound, a 2,7-diamino-9-fluorenylidene compound, a tri(p-N-enamine-substituted-aminophenyl) benzene compound, a pyrene compound having one or two ethenyl groups having at least one aryl group, N,N′-di(biphenyl-4-yl)-N,N′-diphenylbiphenyl-4,4′-diamine, N,N,N′,N′-tetra(biphenyl-4-yl)biphenyl-4,4′-diamine, N,N,N′,N′-tetra(biphenyl-4-yl)-3,3′-diethylbiphenyl-4,4′-diamine, 2,2′-(methylenedi-4,1-phenylene)bis[4,5-bis(4-methoxyphenyl)-2H-1,2,3-triazole], 2,2′-(biphenyl-4,4′-diyl)bis(4,5-diphenyl-2H-1,2,3-triazole), 2,2′-(3,3′-dimethylbiphenyl-4,4′-diyl)bis(4,5-diphenyl-2H-1,2,3-triazole), bis[4-(4,5-diphenyl-2H-1,2,3-triazol-2-yl)phenyl](methyl)amine, or the like.

Alternatively, the hole-injection layer 611 can be formed using a composite material in which an acceptor substance is contained in a substance having a high hole-transport property. Note that when the composite material in which an acceptor substance is contained in a substance having a high hole-transport property is used, a material for forming the electrode can be selected regardless of its work function. In other words, besides a material with a high work function, a material with a low work function can also be used as the first electrode 601. As the acceptor substance, 7,7,8,8-tetracyano-2,3,5,6-tetrafluoroquinodimethane (abbreviation: F₄-TCNQ), chloranil, and the like can be given. In addition, a transition metal oxide can be given. In addition, oxides of metals that belong to Group 4 to Group 8 of the periodic table can be given. Specifically, vanadium oxide, niobium oxide, tantalum oxide, chromium oxide, molybdenum oxide, tungsten oxide, manganese oxide, and rhenium oxide are preferable because of their high electron-accepting properties. Among these, molybdenum oxide is especially preferable because it is stable in the air and its hygroscopic property is low and is easily treated.

As the substance having a high hole-transport property used for the composite material, any of a variety of compounds such as an aromatic amine compound, a carbazole derivative, aromatic hydrocarbon, and a high molecular compound (e.g., an oligomer, a dendrimer, or a polymer) can be used. A substance having a hole mobility of 10⁻⁶ cm²/Vs or more is preferably used as the substance having a high hole-transport property used for the composite material. However, a substance other than the above may also be used as long as its hole-transport property is higher than its electron-transport property. The organic compounds which can be used for the composite material will be specifically shown below.

Examples of the aromatic amine compounds that can be used for the composite material include N,N′-bis(4-methylphenyl)(p-tolyl)-N,N′-diphenyl-p-phenylenediamine (abbreviation: DTDPPA), 4,4′-bis[N-(4-diphenylaminophenyl)-N-phenylamino]biphenyl (abbreviation: DPAB), N,N′-bis[4-[bis(3-methylphenyl)amino]phenyl]-N,N′-diphenyl-[1,1′-biphenyl]-4,4′-diamine (abbreviation: DNTPD), 1,3,5-tris[N-(4-diphenylaminophenyl)-N-phenylamino]benzene (abbreviation: DPA3B), and the like.

Specific examples of the carbazole derivatives which can be used for the composite material include 3-[N-(9-phenylcarbazol-3-yl)-N-phenylamino]-9-phenylcarbazole (abbreviation: PCzPCA1), 3,6-bis[N-(9-phenylcarbazol-3-yl)-N-phenylamino]-9-phenylcarbazole (abbreviation: PCzPCA2), 3-[N-(1-naphthyl)-N-(9-phenylcarbazol-3-yl)amino]-9-phenylcarbazole (abbreviation: PCzPCN1), and the like.

In addition, examples of the carbazole derivatives which can be used for the composite material include 4,4′-di(N-carbazolyl)biphenyl (abbreviation: CBP), 1,3,5-tris[4-(N-carbazolyl)phenyl]benzene (abbreviation: TCPB), 9-[4-(10-phenyl-9-anthryl)phenyl]-9H-carbazole (abbreviation: CzPA), 1,4-bis[4-(N-carbazolyl)phenyl]-2,3,5,6-tetraphenylbenzene, and the like.

Examples of the aromatic hydrocarbon which can be used for the composite material include 2-tert-butyl-9,10-di(2-naphthyl)anthracene (abbreviation: t-BuDNA), 2-tert-butyl-9,10-di(1-naphthyl)anthracene, 9,10-bis(3,5-diphenylphenyl)anthracene (abbreviation: DPPA), 2-tert-butyl-9,10-bis(4-phenylphenyl)anthracene (abbreviation: t-BuDBA), 9,10-di(2-naphthyl)anthracene (abbreviation: DNA), 9,10-diphenylanthracene (abbreviation: DPAnth), 2-tert-butylanthracene (abbreviation: t-BuAnth), 9,10-bis(4-methyl-1-naphthyl)anthracene (abbreviation: DMNA), 9,10-bis[2-(1-naphthyl)phenyl]-2-tert-butylanthracene, 9,10-bis[2-(1-naphthyl)phenyl]anthracene, 2,3,6,7-tetramethyl-9,10-di(1-naphthyl)anthracene, 2,3,6,7-tetramethyl-9,10-di(2-naphthyl)anthracene, 9,9′-bianthryl, 10,10′-diphenyl-9,9′-bianthryl, 10,10′-bis(2-phenylphenyl)-9,9′-bianthryl, 10,10′-bis[(2,3,4,5,6-pentaphenyl)phenyl]-9,9′-bianthryl, anthracene, tetracene, rubrene, perylene, 2,5,8,11-tetra(tert-butyl)perylene, and the like. Besides those, pentacene, coronene, or the like can also be used. In particular, the aromatic hydrocarbon which has a hole mobility of 1×10⁻⁶ cm²/Vs or more and which has 14 to 42 carbon atoms is particularly preferable.

The aromatic hydrocarbon which can be used for the composite material may have a vinyl skeleton. As the aromatic hydrocarbon having a vinyl group, the following are given for example: 4,4′-bis(2,2-diphenylvinyl)biphenyl (abbreviation: DPVBi); 9,10-bis[4-(2,2-diphenylvinyl)phenyl]anthracene (abbreviation: DPVPA); and the like.

Alternatively, for the hole-injection layer 611, it is possible to use a high molecular compound (oligomer, dendrimer, polymer, or the like). Examples of the high molecular compounds include poly(N-vinylcarbazole) (abbreviation: PVK), poly(4-vinyltriphenylamine) (abbreviation: PVTPA), poly[N-(4-{N′-[4-(4-diphenylamino)phenyl]phenyl-N′-phenylamino}phenyl)methacrylamide] (abbreviation: PTPDMA), poly[N,N′-bis(4-butylphenyl)-N,N′-bis(phenyl)benzidine] (abbreviation: Poly-TPD), and the like. Alternatively, a high molecular compound to which acid is added, such as poly(3,4-ethylenedioxythiophene)/poly(styrenesulfonic acid) (PEDOT/PSS), or polyaniline/poly(styrenesulfonic acid) (PAni/PSS), can be used.

Further, the hole-injection layer 611 may be formed using a composite material of the above-described high molecular compound, such as PVK, PVTPA, PTPDMA, or Poly-TPD, and the above-described acceptor substance.

The hole-transport layer 612 contains a substance having a high hole-transport property. Examples of the substance having a high hole-transport property include aromatic amine compounds such as 4,4′-bis[N-(1-naphthyl)-N-phenylamino]biphenyl (abbreviation: NPB), N,N′-bis(3-methylphenyl)-N,N′-diphenyl-[1,1′-biphenyl]-4,4′-diamine (abbreviation: TPD), 4,4′,4″-tris(N,N-diphenylamino)triphenylamine (abbreviation: TDATA), [N-(3-methylphenyl)-N-phenylamino]triphenylamine (abbreviation: MTDATA), 4,4′-bis[N-(spiro-9,9′-bifluoren-2-yl)-N-phenylamino]biphenyl (abbreviation: BSPB), and the like. The substances mentioned here are mainly ones that have a hole mobility of 10⁻⁶ cm²/Vs or more. However, a substance other than the above may also be used as long as its hole-transport property is higher than its electron-transport property. The layer containing a substance with a high hole-transport property is not limited to a single layer, and two or more layers containing the aforementioned substances may be stacked.

Further alternatively, for the hole-transport layer 612, a high molecular compound such as PVK, PVTPA, PTPDMA, or Poly-TPD can be used. Further, the hole-transport layer 612 can be formed using a tris(p-enamine-substituted-aminophenyl)amine compound, a 2,7-diamino-9-fluorenylidene compound, a tri(p-N-enamine-substituted-aminophenyl) benzene compound, a pyrene compound having one or two ethenyl groups having at least one aryl group, N,N′-di(biphenyl-4-yl)-N,N′-diphenylbiphenyl-4,4′-diamine, N,N,N′,N′-tetra(biphenyl-4-yl)biphenyl-4,4′-diamine, N,N,N′,N′-tetra(biphenyl-4-yl)-3,3′-diethylbiphenyl-4,4′-diamine, 2,2′-(methylenedi-4,1-phenylene)bis[4,5-bis(4-methoxyphenyl)-2H-1,2,3-triazole], 2,2′-(biphenyl-4,4′-diyl)bis(4,5-diphenyl-2H-1,2,3-triazole), 2,2′-(3,3′-dimethylbiphenyl-4,4′-diyl)bis(4,5-diphenyl-2H-1,2,3-triazole), bis[4-(4,5-diphenyl-2H-1,2,3-triazol-2-yl)phenyl](methyl)amine, or the like.

The light-emitting layer 613 is a layer containing a substance having a high light-emitting property. The light-emitting layer 613 may contain only a substance with a high light-emitting property or may contain a substance with a high light-emitting property dispersed in another substance.

In the case where the light-emitting layer 613 contains only a substance having a high light-emitting property, for example, an anthracene derivative, a substance having a high light-emitting property among the above-described substances having a high hole-transport property, or a substance having a high light-emitting property among substances described later having a high electron-transport property can be used.

As a substance having a high light-emitting property which is dispersed in another substance to be used for the light-emitting layer 613, any of a variety of materials can be used. Specifically, the following fluorescent substances which emit fluorescence can be used: N,N′-diphenylquinacridone (abbreviation: DPQd), coumarin 6, coumarin 545T, 4-(dicyanomethylene)-2-methyl-6-(p-dimethylaminostyryl)-4H-pyran (abbreviation: DCM1), 4-(dicyanomethylene)-2-methyl-6-(julolidin-4-yl-vinyl)-4H-pyran (abbreviation: DCM2), N,N-dimethylquinacridone (abbreviation: DMQd), {2-(1,1-dimethylethyl)-6-[2-(2,3,6,7-tetrahydro-1,1,7,7-tetramethyl-1H,5H-benzo[ij]quinolizin-9-yl)ethenyl]-4H-pyran-4-ylidene}propanedinitrile (abbreviation: DCJTB), 5,12-diphenyltetracene (abbreviation: DPT), N,9-diphenyl-N-[4-(10-phenyl-9-anthryl)phenyl]-9H-carbazol-3-amine (abbreviation: PCAPA), N,N″-(2-tert-butylanthracene-9,10-diyldi-4,1-phenylene)bis[N,N,N′-triphenyl-1,4-phenylenediamine] (abbreviation: DPABPA), N,N′-diphenyl-N,N′-bis(9-phenylcarbazol-3-yl)stilbene-4,4′-diamine (abbreviation: PCA2S), 2,5,8,11-tetra(tert-butyl)perylene (abbreviation: TBP), perylene, rubrene, 1,3,6,8-tetraphenylpyrene, bis[3-(1H-benzimidazol-2-yl)fluoren-2-olato]zinc(II), bis[3-(1H-benzimidazol-2-yl)fluoren-2-olato]beryllium(II), bis[2-(1H-benzimidazol-2-yl)dibenzo[b,d]furan-3-olato](phenolato)aluminum(III), bis[2-(benzoxazol-2-yl)-7,8-methylenedioxydibenzo[b,d]furan-3-olato](2-naphtholato)aluminum(III), and the like. Besides, it is possible to use a compound in which six or more aryl groups are substituted at terphenyl. Further, phosphorescent substances that emit phosphorescence such as (acetylacetonato)bis[2,3-bis(4-fluorophenyl)quinoxalinato]iridium(III) (abbreviation: Ir(Fdpq)₂(acac)) and 2,3,7,8,12,13,17,18-octaethyl-21H,23H-porphyrinplatinum(II) (abbreviation: PtOEP) can be used.

As a substance in which the substance having a high light-emitting property is dispersed and which is used for the light-emitting layer 613, any of a variety of materials can be used. For example, besides the substances having a high hole-transport property described above or substances having a high electron-transport property described later, there are 4,4′-bis(N-carbazolyl)biphenyl (abbreviation: CBP), 2,2′,2″-(1,3,5-benzenetriyl)tris[1-phenyl-1H-benzimidazole] (abbreviation: TPBI), 9,10-di(2-naphthyl)anthracene (abbreviation: DNA), 2-tert-butyl-9,10-di(2-naphthyl)anthracene (abbreviation: t-BuDNA), 9-[4-(N-carbazolyl)]phenyl-10-phenylanthracene (abbreviation: CzPA), and the like.

Alternatively, as the substance in which the substance having a high light-emitting property is dispersed and which is used for the light-emitting layer 613, a high molecular material can be used. For example, poly(N-vinylcarbazole) (abbreviation: PVK); poly(4-vinyltriphenylamine) (abbreviation: PVTPA); poly[N-(4-{N′-[4-(4-diphenylamino)phenyl]phenyl-N′-phenylamino}phenyl)methacrylamide] (abbreviation: PTPDMA); poly[N,N′-bis(4-butylphenyl)-N,N′-bis(phenyl)benzidine] (abbreviation: Poly-TPD); poly[(9,9-dihexylfluorene-2,7-diyl)-co-(pyridine-3,5-diyl)] (abbreviation: PF-Py); poly[(9,9-dioctylfluorene-2,7-diyl)-co-(2,2′-bipyridine-6,6′-diyl)] (abbreviation: PF-BPy); or the like can be used. Alternatively, it is possible to use a compound in which six or more aryl groups are substituted at terphenyl, 4,4′-bis(2,2-diphenylvinyl)-1,1′-binaphthyl, 4,4′-bis[2,2-bis(4-methylphenyl)vinyl]-1,1′-binaphthyl, 4,4′-bis[2,2-bis(4-methoxyphenyl)vinyl]-1,1′-binaphthyl, 4,4′-bis(2-methyl-2-phenylvinyl)-1,1′-binaphthyl, 4,4′-distyryl-1,1′-binaphthyl, 4,4′-bis[2-(2-naphtyl)-2-phenylvinyl]-1,1′-binaphthyl, 4,4′-bis[2-(1-naphtyl)-2-phenylvinyl]-1,1′-binaphthyl, 4,4′-bis[2-(biphenyl-4-yl)-2-phenylvinyl]-1,1′-binaphthyl, bis[3-(1H-benzimidazol-2-yl)fluoren-2-olato]zinc(II), bis[3-(1H-benzimidazol-2-yl)-fluoren-2-olato]beryllium(II), bis[2-(1H-benzimidazol-2-yl)dibenzo[b,d]furan-3-olato](phenolato)aluminum(III), bis[2-(benzoxazol-2-yl)-7,8-methylenedioxydibenzo[b,d]furan-3-olato](2-naphtholato)aluminum(III), or the like.

The electron-transport layer 614 is a layer containing a substance having a high electron-transport property. For example, the following can be used for the electron-transporting layer 614: a metal complex having a quinoline skeleton or a benzoquinoline skeleton, such as tris(8-quinolinolato)aluminum (abbreviation: Alq), tris(4-methyl-8-quinolinolato)aluminum (abbreviation: Almq₃), bis(10-hydroxybenzo[h]quinolinato)beryllium (abbreviation: BeBq₂), or bis(2-methyl-8-quinolinolato)(4-phenylphenolato)aluminum (abbreviation: BAlq), or the like. Alternatively, a metal complex having an oxazole-based or thiazole-based ligand, such as bis[2-(2-hydroxyphenyl)benzoxazolato]zinc (abbreviation: Zn(BOX)₂) or bis[2-(2-hydroxyphenyl)benzothiazolato]zinc (abbreviation: Zn(BTZ)₂), or the like can be used. Besides the metal complexes, 2-(4-biphenylyl)-5-(4-tert-butylphenyl)-1,3,4-oxadiazole (abbreviation: PBD), 1,3-bis[5-(p-tert-butylphenyl)-1,3,4-oxadiazole-2-yl]benzene (abbreviation: OXD-7), 3-(4-biphenylyl)-4-phenyl-5-(4-tert-butylphenyl)-1,2,4-triazole (abbreviation: TAZ), bathophenanthroline (abbreviation: BPhen), bathocuproine (abbreviation: BCP), bis[3-(1H-benzimidazol-2-yl)fluoren-2-olato]zinc(II), bis[3-(1H-benzimidazol-2-yl)fluoren-2-olato]beryllium(II), bis[2-(1H-benzimidazol-2-yl)dibenzo[b,d]furan-3-olato] (phenolato)aluminum(III), bis[2-(benzoxazol-2-yl)-7,8-methylenedioxydibenzo[b,d]furan-3-olato](2-naphtholato)aluminum(III), or the like can also be used. The substances mentioned here are mainly ones that have an electron mobility of 10⁻⁶ cm²/Vs or more. However, a substance other than the above may also be used for the electron-transport layer, as long as its electron-transport property is higher than its hole-transport property. The electron-transport layer is not limited to a single layer, and two or more layers containing the aforementioned substances may be stacked.

For the electron-transport layer 614, a high molecular compound can be used. For example, poly[(9,9-dihexylfluorene-2,7-diyl)-co-(pyridine-3,5-diyl)] (abbreviation: PF-Py), poly[(9,9-dioctylfluorene-2,7-diyl)-co-(2,2′-bipyridine-6,6′-diyl)] (abbreviation: PF-BPy), or the like can be used.

An electron-injection layer may be provided between the electron-transport layer 614 and the second electrode 603. The electron-injection layer can be formed using an alkali metal compound or an alkaline earth metal compound such as lithium fluoride (LiF), cesium fluoride (CsF), or calcium fluoride (CaF₂). Further, a layer in which a substance having an electron-transport property is combined with an alkali metal or an alkaline earth metal can be employed. For example, a layer formed of Alq to which magnesium (Mg) is added can be used. Note that it is preferable that the layer in which a substance having an electron-transport property is combined with an alkali metal or an alkaline earth metal be used as the electron-injection layer because electrons are efficiently injected from the second electrode 603.

The second electrode 603 is preferably formed using a metal, an alloy, an electrically conductive compound, a mixture thereof, or the like, having a low work function (specifically, a work function of 3.8 eV or lower is preferable). Specific examples of such cathode materials include elements belonging to Group 1 and Group 2 of the periodic table, i.e., alkali metals such as lithium (Li) and cesium (Cs) and alkaline earth metals such as magnesium (Mg), calcium (Ca), and strontium (Sr); alloys containing these (e.g., MgAg and AlLi); rare earth metals such as europium (Eu) and ytterbium (Yb); alloys containing these; and the like. A film of an alkali metal, an alkaline earth metal, or an alloy containing these metals can be formed by a vacuum evaporation method. An alloy containing an alkali metal or an alkaline earth metal can also be formed by a sputtering method. Further, a silver paste or the like can be formed by an inkjet method or the like.

Further, when the electron-injection layer is provided between the second electrode 603 and the electron-transport layer 614, any of a variety of conductive materials such as Al, Ag, ITO, and ITO containing silicon or silicon oxide can be used for the second electrode 603 regardless of its work function. Films of these conductive materials can be formed by a sputtering method, an ink-jet method, a spin coating method, or the like.

In the light-emitting element having the above structure, which is described in this embodiment, current flows by application of voltage between the first electrode 601 and the second electrode 603. Then, holes and electrons are recombined in the light-emitting layer 613 that is a layer containing a substance having a high light-emitting property. In other words, the light-emitting region is formed in the light-emitting layer 613.

Emitted light is extracted outside through one or both of the first electrode 601 and the second electrode 603. Accordingly, one or both of the first electrode 601 and the second electrode 603 is/are an electrode having a light-transmitting property. When only the first electrode 601 has a light-transmitting property, light is extracted from the substrate 600 side through the first electrode 601. When only the second electrode 603 has a light-transmitting property, light is extracted from the side opposite to the substrate 600 through the second electrode 603. When the first electrode 601 and the second electrode 603 both have a light-transmitting property, light is extracted from both the substrate 600 side and the side opposite to the substrate 600 through the first electrode 601 and the second electrode 603.

Although FIG. 6 illustrates a structure in which the first electrode 601 which functions as an anode is provided on the substrate 600 side, the second electrode 603 which functions as a cathode may be provided on the substrate 600 side. Note that in this case, it is preferable that a TFT connected to the second electrode 603 be an n-channel TFT.

Any of a variety of methods can be employed for forming the layer 602 containing an organic compound regardless of whether it is a dry process or a wet process. A different formation method may be employed for each electrode or each layer. A vacuum evaporation method, a sputtering method, or the like can be employed as a dry process. An ink-jet method, a spin-coating method, or the like can be employed as a wet process.

The electrodes may be formed by a wet process such as a sol-gel method, or by a wet process using a paste of a metal material. Alternatively, the electrodes may be formed by a dry process such as a sputtering method or a vacuum evaporation method.

Hereinafter, a specific formation method of a light-emitting element will be described. When the light-emitting element of one embodiment of the present invention is applied to a display device and light-emitting layers are formed separately for each color, it is preferable that the light-emitting layers be formed by a wet process. The use of a wet process such as an inkjet method makes it easier to form light-emitting layers separately for each color even when a large substrate is employed, whereby productivity is improved.

For example, in the structure described in this embodiment, the first electrode 601 may be formed by a sputtering method, which is a dry process; the hole-injection layer 611 may be formed by an ink-jet method or a spin coating method, which are wet processes; the hole-transport layer 612 may be formed by a vacuum evaporation method, which is a dry process; the light-emitting layer 613 may be formed by an ink-jet method, which is a wet process; the electron-transport layer 614 may be formed by a co-evaporation method, which is a dry process; and the second electrode 603 may be formed by an ink-jet method or a spin coating method, which are wet processes. Furthermore, the first electrode 601 may be formed by an ink-jet method, which is a wet process; the hole-injection layer 611 may be formed by a vacuum evaporation method, which is a dry process; the hole-transport layer 612 may be formed by an ink-jet method or a spin coating method, which are wet processes; the light-emitting layer 613 may be formed by an ink-jet method, which is a wet process; the electron-transport layer 614 may be formed by an ink-jet method or a spin coating method, which are wet processes; and the second electrode 603 may be formed by an ink-jet method or a spin coating method, which are wet processes. Without limitation to the above-described methods, a wet process and a dry process may be combined as appropriate.

Alternatively, for example, the first electrode 601 may be formed by a sputtering method which is a dry process; the hole-injection layer 611 and the hole-transport layer 612 may be formed by an ink-jet method or a spin coating method, which are wet processes; the light-emitting layer 613 may be formed by an ink jet method which is a wet process; the electron-transport layer 614 may be formed by a vacuum evaporation method, which is a dry process; and the second electrode 603 may be formed by a vacuum evaporation method which is a dry process. That is, it is possible to form the hole-injection layer 611 to the light-emitting layer 613 by wet processes over the substrate where the first electrode 601 is formed in a desired shape and to form the electron-transport layer 614 to the second electrode 603 by dry processes. In this method, the formation of the hole-injection layer 611 to the light-emitting layer 613 can be performed at atmospheric pressure, and the light-emitting layers 613 can be easily formed separately for each color. In addition, the electron-transport layer 614 to the second electrode 603 can be consecutively formed in vacuum. Therefore, the process can be simplified and productivity can be improved.

In the case of formation by a wet process, a liquid composition in which a substance with a high hole-injection property, a substance with a high hole-transport property, a substance with a high light-emitting property, or a substance with a high electron-transport property is dissolved in a solvent can be used. In this case, after the liquid composition including the above substance and the solvent is attached to a region where a thin film is to be formed, the solvent is removed by heat treatment or the like and the above substance is solidified, whereby the thin film is formed.

In the light-emitting element of this embodiment which has the structure described above, the potential difference generated between the first electrode 601 and the second electrode 603 makes current flow, whereby holes and electrons are recombined in the light-emitting layer 613 that contains a substance having a high light-emitting property and accordingly light is emitted. In other words, the light-emitting region is formed in the light-emitting layer 613.

The structure of layers provided between the first electrode 601 and the second electrode 603 is not limited to the above example. A structure other than the above may alternatively be employed as long as a light-emitting region in which holes and electrons are recombined is provided in a portion away from the first electrode 601 and the second electrode 603 in order to prevent quenching due to proximity of the light-emitting region to metal.

For example, a structure may be employed in which a hole-transport layer is not provided and an electron-injection suppression layer is provided for suppressing injection of electrons from the hole-injection layer including an acceptor and from the light-emitting layer. In that case, it is preferable that the electron affinity of a material for forming the electron-injection suppression layer be smaller than those of a material for forming the light-emitting layer and the acceptor. Alternatively, a structure may be employed in which not an electron-transport layer but a hole-injection suppression layer is provided for suppressing injection of holes from the electron-injection layer including a donor and from the light-emitting layer. In that case, it is preferable that the ionization potential of a material for forming the hole-injection suppression layer be larger than those of a material for forming the light-emitting layer and the donor.

Further, the light-emitting element described in this embodiment may have a structure in which two or more layers of the hole-injection layer 611 and two or more layers of the hole-transport layer 612 described above are alternately stacked. Further, the electrode which serves as a cathode may have a three-layer structure in which a second metal electrode which prevents oxidation is interposed between an oxide transparent conductive film and a metal electrode.

When the light-emitting element described in this embodiment including the layer containing a light-emitting organic compound between the first electrode and the second electrode is mounted on any of the light-emitting modules described in Embodiments 1 to 3, a light-emitting device in which driving and light adjustment can be performed using one constant current supply without the entire lighting being turned off by disconnection (an insulation defect) in part of light-emitting elements can be provided. Further, a light-emitting device in which light can be adjusted without unequal use of part of a plurality of light-emitting elements can be provided.

A light-emitting device which is thin and light weight, has very high response speed and large area, and can maintain uniform luminance can be provided.

Thus, a light-emitting device can have a long lifetime with its brightness as a whole kept uniform.

Note that this embodiment can be freely combined with the other embodiments.

### Embodiment 5

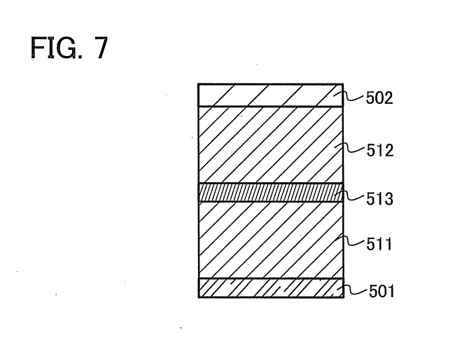

In this embodiment, one mode of a light-emitting element (hereinafter referred to as a stacked element) including a stack of the plurality of layers each containing a light-emitting organic compound according to the above embodiment (hereinafter referred to as a light-emitting unit) will be described with reference to FIG. 7. This light-emitting element is a light-emitting element including a plurality of light-emitting units between a first electrode and a second electrode. Each light-emitting unit can have a structure similar to that of the layer 602 containing an organic compound described in Embodiment 4. That is, the light-emitting element described in Embodiment 4 is a light-emitting element having a single light-emitting unit. In this embodiment, a light-emitting element having a plurality of light-emitting units is described.

In FIG. 7, a first light-emitting unit 511 and a second light-emitting unit 512 are stacked between a first electrode 501 and a second electrode 502. As the first electrode 501 and the second electrode 502, electrodes similar to those in Embodiment 4 can be applied. The first light-emitting unit 511 and the second light-emitting unit 512 may have the same structure or different structures, and the structure of the layer containing an organic compound described in Embodiment 4 can be applied thereto.

A charge generation layer 513 contains a composite material of an organic compound and a metal oxide. The composite material of an organic compound and a metal oxide is described in Embodiment 4, and contains an organic compound and a metal oxide such as vanadium oxide, molybdenum oxide, or tungsten oxide. As the organic compound, various compounds such as an aromatic amine compound, a carbazole derivative, aromatic hydrocarbon, and a high molecular compound (oligomer, dendrimer, polymer, or the like) can be used. As the organic compound, it is preferable to use an organic compound which has a hole-transport property and has a hole mobility of 10⁻⁶ cm²/Vs or more. However, a substance other than the above may also be used as long as its hole-transport property is higher than its electron-transport property. The composite material of the organic compound and the metal oxide can achieve low-voltage driving and low-current driving because of its superior carrier-injection property and carrier-transport property.

Note that the charge generation layer 513 may be formed by combining the composite material of the organic compound and the metal oxide with another material. For example, a layer containing the composite material of the organic compound and the metal oxide may be combined with a layer containing a compound of a substance selected from substances with an electron-donating property and a compound with a high electron-transport property. Moreover, a layer containing the composite material of the organic compound and the metal oxide may be combined with a transparent conductive film.

In any case, any layer can be employed as the charge generation layer 513 sandwiched between the first light-emitting unit 511 and the second light-emitting unit 512 as long as the layer injects electrons into one of these light-emitting units and holes into the other when voltage is applied to the first electrode 501 and the second electrode 502. For example, in FIG. 7, any layer can be employed as the charge-generation layer 513 as long as the charge-generation layer 513 injects electrons and holes into the first light-emitting unit 511 and the second light-emitting unit 512, respectively, when voltage is applied so that the potential of the first electrode 501 is higher than that of the second electrode 502.

Although this embodiment describes the light-emitting element having two light-emitting units, one embodiment of the present invention can be similarly applied to a light-emitting element in which three or more light-emitting units are stacked. When a plurality of light-emitting units which are partitioned by the charge generation layer are arranged between a pair of electrodes, as in the light-emitting element of this embodiment, it is possible to provide a light-emitting element which has a long lifetime and is able to emit light in a high luminance region while current density is kept low.

With light-emitting units having emission colors different from each other, the light-emitting element as a whole can be made to emit light with a desired color. For example, in a light-emitting element having two light-emitting units, the emission colors of the first light-emitting unit and the second light-emitting unit are made complementary; thus, the light-emitting element which emits white light as a whole can be obtained. Note that the word “complementary” means color relationship in which an achromatic color is obtained when colors are mixed. That is, white light emission can be obtained by mixture of light obtained from substances emitting lights with complementary colors. The same can be applied to a light-emitting element which has three light-emitting units. For example, the light-emitting element as a whole can emit white light when the emission color of the first light-emitting unit is red, the emission color of the second light-emitting unit is green, and the emission color of the third light-emitting unit is blue.

Note that this embodiment can be freely combined with the other embodiments.

### Embodiment 6

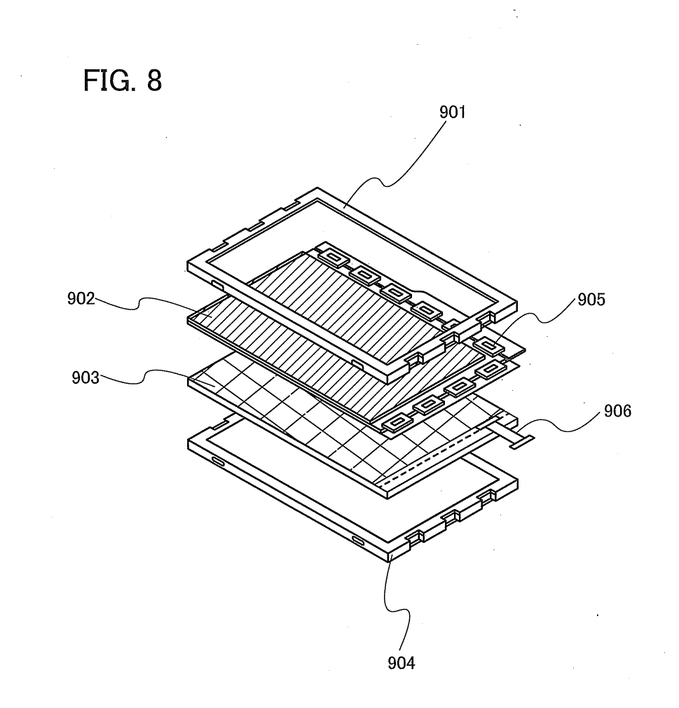

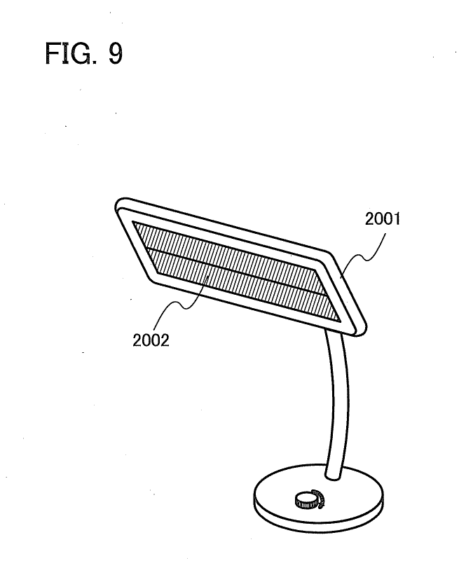

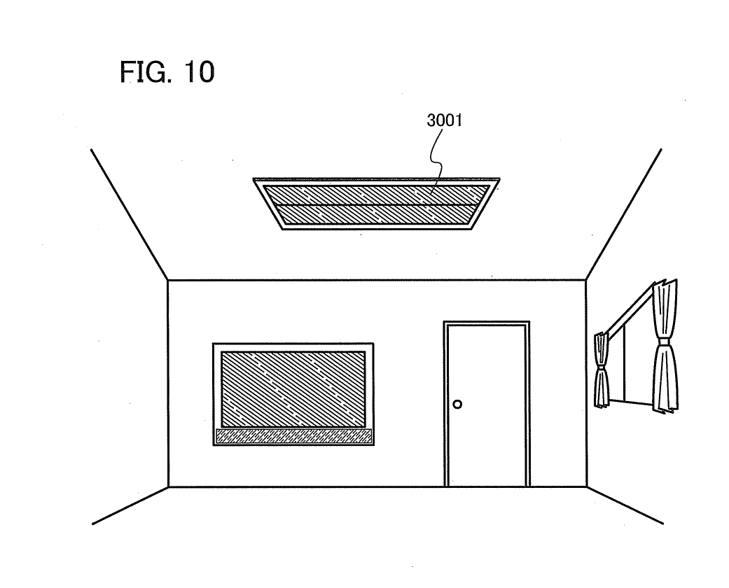

One mode of using the light-emitting device of one embodiment of the present invention as a lighting device will be described with reference to FIG. 8, FIG. 9, and FIG. 10.

FIG. 8 illustrates an example of a liquid crystal display device using the light-emitting device of one embodiment of the present invention as a backlight. The liquid crystal display device illustrated in FIG. 8 includes a housing 901, a liquid crystal layer 902, a backlight 903, and a housing 904, and the liquid crystal layer 902 is connected to a driver IC 905. The light-emitting device of one embodiment of the present invention is used as the backlight 903, and current is supplied through a terminal 906.

The light-emitting device of one embodiment of the present invention is used as the backlight of the liquid crystal display device, whereby a backlight having high emission efficiency and reduced power consumption can be provided. In addition, the light-emitting device of one embodiment of the present invention is a surface emission lighting device and can have a larger area. Therefore, the backlight can also have a larger area, which enables the liquid crystal display device to have a larger area. Moreover, since the light-emitting device of one embodiment of the present invention is thin and consumes less power, reduction in the thickness and power consumption of a display device can also be achieved. Since the light-emitting device of one embodiment of the present invention has a long lifetime, a liquid crystal display device using the light-emitting device of one embodiment of the present invention also has a long lifetime.

FIG. 9 is an example in which the light-emitting device of one embodiment of the present invention is used as a desk lamp that is a lighting device. The desk lamp illustrated in FIG. 9 includes a housing 2001 and a light source 2002. The light-emitting device of one embodiment of the present invention is used as the light source 2002. The light-emitting device of one embodiment of the present invention has high emission efficiency and has a long lifetime; therefore, a desk lamp also has high emission efficiency and a long lifetime.

FIG. 10 illustrates an example in which the light-emitting device to which one embodiment of the present invention is applied is used for an indoor lighting device 3001. Since the light-emitting device of one embodiment of the present invention can have a larger area, the light-emitting device of one embodiment of the present invention can be used as a lighting device having a large area. In addition, since the light-emitting device of one embodiment of the present invention is thin and consumes less power, it can be used as a thin lighting device with low power consumption.

According to this embodiment, a lighting device in which driving and light adjustment can be performed using one constant current supply without the entire lighting being turned off by disconnection (an insulation defect) in part of light-emitting elements can be provided. Further, a lighting device in which light can be adjusted without unequal use of part of a plurality of light-emitting elements can be provided.

Note that this embodiment can be freely combined with the other embodiments.

This application is based on Japanese Patent Application serial no. 2010-080756 filed with Japan Patent Office on Mar. 31, 2010, the entire contents of which are hereby incorporated by reference.

What is claimed is:

1. A light-emitting device comprising:
a plurality of light-emitting panels;
a constant current supply configured to supply an electric power to each of the light-emitting panels;
a luminance control unit configured to set a brightness of the light-emitting panels; and
a light-emission control unit configured to make an output of the constant current supply be sequentially supplied in accordance with a signal from the luminance control unit so that the light-emitting panels blink with a same frequency,
wherein the light-emitting panels each include a light-emitting element including a layer containing a light-emitting organic compound between a first electrode and a second electrode.

2. The light-emitting device according to claim 1, wherein the light-emission control unit is configured to control a current output from the constant current supply.

3. The light-emitting device according to claim 1, wherein the light-emission control unit is configured to control a pulse width of a current output from the constant current supply.

4. The light-emitting device according to claim 1,
wherein the constant current supply is configured to supply a constant current to each of the light-emitting panels with a frequency of greater than or equal to 100 Hz and less than or equal to 500 kHz in accordance with a control signal output from the light-emission control unit.

5. A light-emitting device comprising:
a plurality of light-emitting panels;
a constant current supply configured to supply an electric power to each of the light-emitting panels;
a luminance control unit configured to set a brightness of the light-emitting panels; and
a light-emission control unit configured to make an output of the constant current supply be sequentially supplied in accordance with a signal from the luminance control unit so that the light-emitting panels blink with a same frequency,
wherein the light-emitting panels each include a light-emitting element which includes a plurality of light-emitting units each containing an organic compound between a first electrode and a second electrode, and which also includes a charge generation layer between the plurality of light-emitting units.

6. The light-emitting device according to claim 5, wherein the light-emission control unit is configured to control a current output from the constant current supply.

7. The light-emitting device according to claim 5, wherein the light-emission control unit is configured to control a pulse width of a current output from the constant current supply.

8. The light-emitting device according to claim 5,
wherein the constant current supply is configured to supply a constant current to each of the light-emitting panels with a frequency of greater than or equal to 100 Hz and less than or equal to 500 kHz in accordance with a control signal output from the light-emission control unit.

9. A driving method of a light-emitting device comprising the steps of:
preparing m light-emitting modules (m is more than or equal to 2 and less than or equal to 10) each of which is provided with n light-emitting panels (n is more than or equal to 2 and less than or equal to 10000) each provided with a light-emitting element including a layer containing a light-emitting organic compound between a first electrode and a second electrode, n first terminals electrically connected to the first electrode of each light-emitting panel, and n second terminals electrically connected to the second electrode of each light-emitting panel;
connecting one of the second terminals for the light-emitting panels provided in one of the light-emitting modules to one of the first terminals for the light-emitting panels provided in another one of the light-emitting modules to form n light-emitting bodies in each of which m light-emitting panels are connected in series;
connecting a terminal connected to each first electrode of the n light-emitting bodies to one electrode of a constant current supply;
connecting a terminal connected to each second electrode of the n light-emitting bodies to the other electrode of the constant current supply; and
supplying an electric power to the n light-emitting bodies from the constant current supply controlled by a light-emission control unit in accordance with a signal from a luminance control unit to blink the n light-emitting bodies with the same frequency.

10. A driving method of a light-emitting device which includes a plurality of light-emitting panels, the driving method comprising a step of:
sequentially lighting each of the plurality of light-emitting panels by supplying a current in a pulse form,
wherein each of the plurality of light-emitting panels comprises a light-emitting layer comprising an organic compound.

11. The driving method according to claim 10 further comprising a step of adjusting a brightness of the light-emitting device by changing a current value of the current.

12. The driving method according to claim 10 further comprising a step of adjusting a brightness of the light-emitting device by changing a pulse width of the current.

13. The driving method according to claim 10 further comprising a step of adjusting a brightness of the light-emitting device by changing a duty ratio of the current.

14. The driving method according to claim 10 wherein the current is a constant current.
